(19) United States
(12) Patent Application Publication
(10) Pub. No.: US 2016/0029059 A1
(43) Pub. Date: Jan. 28, 2016

(54) Methods and apparatus for vending and delivering the content of disk recordings

(71) Applicant: Compass Innovations, LLC, Redwood City, CA (US)

(72) Inventors: James D. Logan, Candia, NH (US); Daniel M. Morton, Somerville, MA (US)

(21) Appl. No.: 14/639,016

(22) Filed: Mar. 4, 2015

Related U.S. Application Data
(63) Continuation of application No. 11/142,831, filed on Jun. 1, 2005, now abandoned.
Application No. 11/142,831 is a continuation-in-part of application No. 09/238,948, filed on Jan. 27, 1999, now Pat. No. 7,055,166.
Application No. 09/238,948 is a continuation-in-part of application No. 09/536,969, filed on Mar. 28, 2000, now Pat. No. 6,931,451.
Application No. 09/536,969 is a continuation-in-part of application No. 09/782,546, filed on Feb. 13, 2001, now Pat. No. 7,509,178.
Application No. 09/782,546 is a continuation-in-part of application No. 10/060,001, filed on Jan. 29, 2002, now abandoned.
Application No. 10/060,001 is a continuation-in-part of application No. 10/165,587, filed on Jun. 8, 2002, now abandoned.
Application No. 10/165,587 is a continuation-in-part of application No. 10/767,926, filed on Jan. 29, 2004, now abandoned.
Application No. 10/767,926 is a continuation-in-part of application No. 10/767,947, filed on Jan. 29, 2004, now abandoned.
Application No. 10/767,947 is a continuation-in-part of application No. 10/331,198, filed on Dec. 30, 2002, now Pat. No. 7,058,376.
(60) Provisional application No. 60/575,871, filed on Jun. 1, 2004.

(51) Int. Cl. H04N 21/2543; H04N 21/258

(52) U.S. Cl. CPC H04N 21/2543; H04N 21/25875

(57) ABSTRACT

A DVD player/recorder incorporates a hard drive mass memory device for temporarily storing program content and metadata, includes a network interface for connecting to content and metadata providers, as well as other resources and other computers, via the Internet, a television interface for connecting to a conventional television set which reproduces content from the DVD player, and also connects the DVD player to a set top box which provides a connection to a cable or satellite provider which forms a further source of programming and metadata. The DVD player can retrieve and play content, and permit the navigation of content, specified on a metadata playlist file.

### CROSS-REFERENCE TO RELATED APPLICATIONS

This application is a non-provisional of, and claims the benefit of the filing date of, U.S. Provisional Application Ser. No. 60/575,871 filed on Jun. 1, 2004.

This application is also a continuation in part of, and claims the benefit of the effective filing date of, U.S. patent application Ser. No. 9/238,948 filed on Jan. 27, 1999 which was a continuation in part of U.S. patent application Ser. No. 08/723,641 filed on Oct. 3, 1996, (now U.S. Pat. No. 5,892,536).

This application is also a continuation in part of, and claims the benefit of the effective filing date of, U.S. patent application Ser. No. 09/536,969 filed on Mar. 28, 2000. application Ser. No. 09/536,969 was a continuation in part of the U.S. patent application Ser. No. 08/780,669 filed on Jan. 7, 1997 and the above noted Ser. No. 08/723,948 filed on Jan. 27, 1999. application Ser. No. 09/536,969 also claimed the benefit of Provisional U.S. Patent Application Ser. No. 60/126,758 filed on Mar. 29, 1999.

This application is also a continuation in part of, and claims the benefit of the effective filing date of, U.S. patent application Ser. No. 09/782,546 filed on Feb. 13, 2001 which was a division of U.S. patent application Ser. No. 08/724,813 filed on Oct. 2, 1996 (now U.S. Pat. No. 6,199,076 issued on Mar. 6, 2001 to James D. Logan et al. and entitled “Audio Program Player including a Dynamic Program Selection Controller”).

This application is also a continuation in part of, and claims the benefit of the effective filing date of, U.S. patent application Ser. No. 10/060,001 filed on Jan. 29, 2002, now published as Patent Application Publication No. 2002/0120925. application Ser. No. 10/060,001 claimed the benefit of the filing dates of Provisional U.S. Patent Application Ser. No. 60/264,868 filed on Jan. 29, 2001, Provisional U.S. Patent Application Ser. No. 60,304,570 filed on Jul. 11, 2001, Provisional U.S. Patent Application Ser. No. 60/336,602 filed on Dec. 3, 2001, and was a continuation in part of U.S. patent application Ser. No. 09/536,696 filed Mar. 28, 2000.

This application is also a continuation in part of and claims the benefit of the effective filing date of, U.S. patent application Ser. No. 10/165,587 filed on Jun. 8, 20002, now published as Patent Application Publication No. 2003/0093790. application Ser. No. 10/165,587 claimed the benefit of the filing date of the following Provisional U.S. Patent Applications: Ser. No. 60/297,204 filed Jun. 8, 2001, Ser. No. 60/352,788 filed on Nov. 28, 2001, Ser. No. 60/304,570 filed on Jul. 11, 2001, and Ser. No. 60/336,602 filed on Dec. 3, 2001. application Ser. No. 10/165,587 was also a continuation in part of U.S. patent application Ser. No. 09/536,969 filed Mar. 18, 2000 and a continuation in part of U.S. patent application Ser. No. 10/060,001 filed Jan. 29, 2002.

This application is also a continuation in part of and claims the benefit of the effective filing date of U.S. patent application Ser. No. 10/767,926 filed on Jan. 29, 2004 and published as Patent Application Publication No. 2004/0255330; application Ser. No. 10/767,926 claimed the benefit of the filing date of Provisional U.S. patent application Ser. No. 60/443,376 filed on Jan. 29, 2003 and was a continuation in part of the following U.S. patent applications: Ser. No. 10/331,198 filed on Dec. 30, 2002, 12/30/2002; Seri. No. 09/536,969 filed on Mar. 28, 2000, Ser. No. 10/060,001 filed on Jan. 29, 2002, and Ser. No. 10/165,587 filed on Jun. 8, 2002.

This application is also a continuation in part of and claims the benefit of the effective filing date of U.S. patent application Ser. No. 10/767,947 filed on Jan. 29, 2004 now published as Publication No. 2004/0268386 which claimed the benefit of the filing date of Provisional U.S. patent application Ser. No. 60/443,378 filed on Jan. 29, 2003 and which was also a continuation in part of the above-identified U.S. patent application Ser. No. 10/165,587 filed on Jun. 8, 2002.

This application is also a continuation in part of, and claims the benefit of the effective filing date of, U.S. patent application Ser. No. 10/331,198 filed on Dec. 30, 2002 now published as Patent Application Publication No. 2003/0163823. application Ser. No. 10/331,198 claimed the benefit of the filing date of Provisional U.S. Patent Application Ser. No. 60/346,418 filed on Dec. 29, 2001, was continuation in part of the following U.S. patent applications: Ser. No. 09/238,948 filed on Jan. 27, 1999, Ser. No. 09/536,969 filed on Mar. 28, 2000, Ser. No. 09/699,176 filed Oct. 28, 2000, 10/28/2000; and Ser. No. 10/060,001 filed on Jan. 20, 2000, Ser. No. 10/165,587 filed on Jun. 8, 2000.

This application is related to U.S. Pat. No. 5,892,536 issued Apr. 6, 1999 to James D. Logan et al. and entitled “Systems and Methods for Computer Enhanced Broadcast Monitoring”; U.S. Pat. No. 5,986,692 issued Nov. 19, 1999 to James D. Logan et al. and entitled “Systems and Methods for Computer Enhanced Broadcast Monitoring”; and U.S. Pat. No. 6,088,455 issued Jul. 11, 2000 to James D. Logan et al. and entitled “Systems and Methods for Modifying Broadcast Programming.”

This application incorporates by reference the disclosures of, each of the foregoing applications, application publications, and issued patents.

### FIELD OF THE INVENTION

This invention relates to electronic audio and video recording and playback devices.

### BACKGROUND OF THE INVENTION

The present invention employs metadata (i.e., data that describes data) to selectively record, play back, edit, distribute and otherwise manipulate recorded audio and video programming content. The invention is built on the principles described in the applications, published patent applications, and issued patents identified above in the “Cross-reference to related applications.”

Consumers who purchase program content commonly purchase media (e.g. DVD and CD-ROM disks) containing recorded program content such as motion pictures and music. The creation of a library of content on media such as DVD or CD-ROM disks presents several disadvantages including the fact that they: take up space; can be lost, scratched or stolen; can be difficult to sort and organize; provide no convenient way to track what a user has seen or restart a movie or an album where it was being played earlier; make it difficult to restricting viewing to certain members of the household; and don't give the purchaser proper credit for multiple purchases. Video-on-demand (VOD) systems enable viewers to purchase rights to programming content, typically movies, for use over a specified time period, and is comparable to renting a media volume containing the same content from a rental outlet. Nonetheless, there has been an increasing demand for “owned” content, and consumers are buying movie DVDs in large numbers when they could just as easily rent the same movies for about one-fifth the cost. It is apparent that consumers believe there is a significant benefit to owning the content, despite the fact that most movies are usually only watched once.

### SUMMARY OF THE INVENTION

The present invention takes the form of methods and apparatus that enable consumers to more easily acquire, manage, index, play back, share and otherwise enjoy content recorded on DVD disks and similar media content.

### BRIEF DESCRIPTION OF THE DRAWINGS

In the detailed description which follows, frequent reference will be made to the attached drawings, in which:

FIG. 1 is a block diagram of the principle hardware components used in an illustrative implementation of the invention.

### DETAILED DESCRIPTION

Hardware Architecture

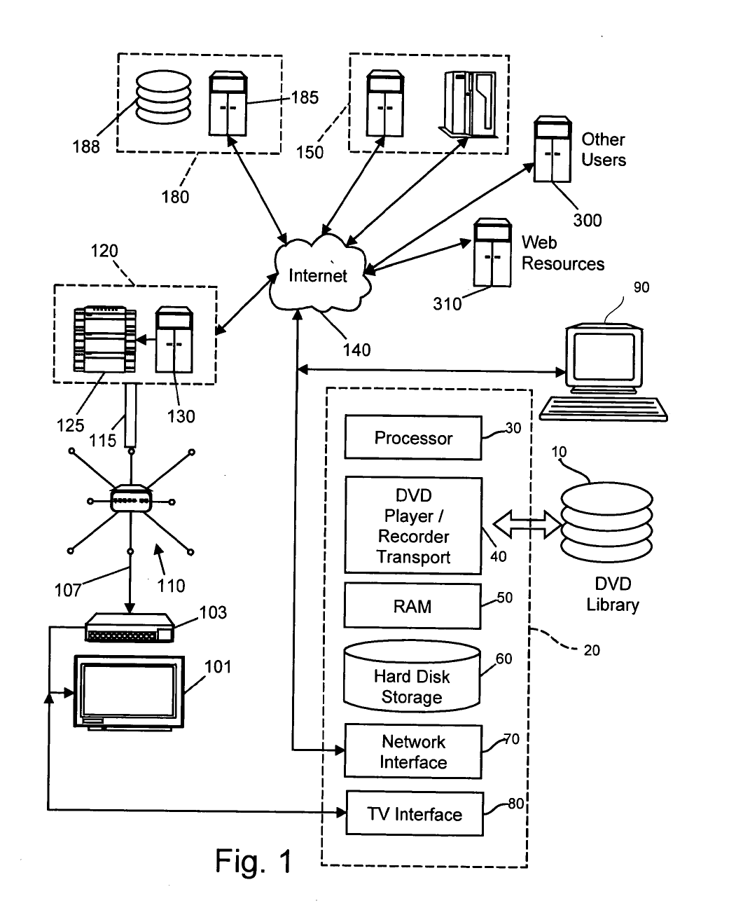

The present invention may be implemented in a variety of hardware environments, one of which is illustrated in FIG. 1 of the drawings.

As contemplated by the invention, a user may employ conventional devices to view or listen to media content of the kind typically recorded on one or more media volumes, such as CD or DVD disks which store assets such as full-length movies, a collection of programs in a broadcast television series, music albums, and music videos. In the description that follows, the media assets most commonly referred to take the form of “movies” of the kind normally available for purchase on physical DVD disks, and the purchased access rights will frequently be referred to as a “Virtual DVD.” It should be understood, however, that the principles of the invention may also be applied to the “virtual purchase” of other kinds of assets, including music collections (“albums”) as sold on CD disks, movies and other video program content sold on cassette tape, and media programming which is available on the Internet or via a cable or satellite provider for purchase, downloading and recording on a DVD drive or the like.

Physical DVD disks seen at 10 which are available to the computer may be played back on a DVD player having expanded capabilities generally indicated at 20 in FIG. 1. The DVD player 20 preferably includes a microprocessor 30 which performs numerous control functions, frequently in response to control commands from a hand held remote control unit (not shown). The DVD player 20 further includes one or more DVD disk transports seen at 40 which accept and playback, and record, content on DVD or CD disks. The player 20 further includes dynamic RAM storage which may be used to store computer programs executable by the processor 30, media content, metadata describing media content from a variety of sources, including the physical disk library 10, and data. One or more hard disk storage units seen at 60 may be employed for persistent storage of executable programs, media content, metadata and other data. A network interface 70 provides connectivity to a locally available PC seen at 90 and to the Internet. A television interface 80 connects the DVD player 20 to a conventional television set seen at 101 and to a set top box 103 that provides a connection to a cable TV network as described below.

In the illustrative embodiment of the invention, a user typically watches video programming from both the DVD player 20 and from a cable system using the television 101 which receives programming via the connected “set top box” 103 that is in turn connected to cable system's facilities, including a subscriber cable 107 connected to a hub 110 that includes one or more edge servers which distribute programming to individual subscribers from the “headend” facility 120.

The connection via the cable systems headend facility 120 and the Internet 140 may be used to provide media content from a content provider 150 and may also supply metadata from a metadata provider 180 which maintains a metadata database at 188 and employs a file server and/or Web server 185 to provide access to the metadata in the database 188, either via the cable network or directly via the Internet to the PC 90 or directly to the DVD player 10 via the network interface 70.

The set top box 103 is conventional and receives commands from a hand-held “remote control” device including a keypad (not shown) that enables the user to navigate and make selections from menu choices displayed on the television set 101. In a similar fashion, the TV interface 80 in the DVD player also displays prompts and menu choices on the TV 101 to guide the user in the course of issuing control commands to the DVD player.

The set top box 103 may also include a built-in digital video recorder which includes its own hard disk memory that permits the user to locally store programs, including movies, received via the connected cable system. This locally stored content may be used alone, or in combination with storage available on the network that acts as a “networked personal video recorder” (nPVR). In addition, the user may employ a separate personal video recorder, such as those marketed by TiVo and ReplayTV. These PVR and nPVR units allow the user to pause, rewind and replay program material received via the cable system. The nPVR functions are typically provided as part of the cable vendor's VOD service which allow the user to watch programs selected from a catalog of currently available VOD offerings.

Typically, when a user selects a given VOD program, it remains available for replay only for a limited amount of time, such as one day. In the illustrative embodiment of FIG. 1, the edge server(s) in the hub 110 receive MPEG-2 video over an IP/Gigabit Ethernet link 115 from a regional headend 120 which includes a video server farm 125. The edge servers at the hub 110 remove the Ethernet and IP headers, process and route the MPEG-2 video packets to the appropriate output, and QAM modulate and up-convert the signals for transmission over the subscriber cable 107 to the set top box 103. The downstream RF subscriber line connection between the hub 110 and the individual subscribers delivers content from the headend to the set-top box. This content includes video assets (programming), VOD catalog information, and other control information used by the VOD system. To efficiently provide VOD services to the subscriber, the provider may employ a hybrid architecture, locating VOD servers at both the headend and at the hubs. For example, an operator may choose to house a server with the ‘top hits’ at the hubs as well and use the headend server farm 125 to store the “deep library”. To provide VOD services comparable to those offered by an interactive cable system, satellite providers typically rely on local storage devices (hard disk storage units built into the set top box) to store media content which is broadcast to and saved by the set top box in advance of being viewed by the user.

As described in the above-noted U.S. Patent Application Serial No. Ser. No. 09/536,969 filed on Mar. 28, 2000, locally stored programming signals at a client location can be processed to derive identification data from a first set of separate programming segments, and this identification data can then be transmitted to a remote processing location where the received identification data is compared with a database containing identification information and associated content descriptions for each of a second set of remotely stored programming segments to identify common program segments found in both the first and said second set of programming segments. The remote host can then transmit content descriptions stored in said database which describe said common program segments, and at said client location, these descriptions can be presented to a user to facilitate the selective processing of said common program segments. In the system described in Application Serial No. Ser. No. 09/536,969, the identification data may be used to establish “ownership” (i.e., the right to reproduce) the common program segments, and a subscriber may be thereafter permitted to download and reproduce selected common segments from any location. The system shown in FIG. 1 extends this capability to permit a user to purchase a “virtual DVD” to obtain many of the advantages of ownership of a physical disk volume without actually acquiring possession of a physical volume.

As described in U.S. patent application Ser. No. 10/767,947 filed on Jan. 29, 2004 now published as Publication No. 2004/0268386 entitled “Virtual DVD Library,” an arrangement may be used to enhance the capabilities of conventional VOD systems of the type described above by providing a mechanism that permits a subscriber to effectively “own” virtual copies of media assets, such as movies, that might be normally be purchased or rented for short term on physical media volumes, such as DVD disks, or provided for short-term use by the cable or satellite vendor's “pay per view” or VOD system. In accordance with the present invention, such assets may instead be purchased as a “virtual copy” providing the advantages of “ownership” as well as additional advantages which cannot be obtained by using purchased physical media volumes. These “virtual copies” may be stored, at any given time, in a variety of locations, including the storage facilities provided by a content provider 150, the headend 120 or hub 110 operated by a MSO, or on the local storage included in the set top box or a separate PVR on the user's premises.

The distribution and management of these “virtual copies” is performed under the supervision of a centralized “virtual asset distributor” seen at 180 which includes a virtual asset management processor 185 and a virtual asset database 188. The virtual asset distributor 180 performs some or all of the following principal functions:

1. Maintaining the virtual asset database 188 which, among other things, identifies the media assets to which purchasers may be given access pursuant to purchase contract;

2. Distributing metadata to prospective purchasers via VOD providers and the like in the form of a catalog of media assets which are available for purchase;

3. Establishing and maintaining customer records reflecting, for each customer, the identification of purchased assets, the terms upon which each purchased asset may be used by the customer, and a history of the actual use of that asset by the customer; and

4. Performing accounting functions for customer billing, payments between content providers and copyright holders, media distributors (such as cable and satellite providers), customers, and the virtual asset distributor.

Although, for purposes of explanation, the virtual asset distributor 180 is described as a separate entity, it should be understood that the virtual asset management functions can be performed and/or controlled by a content provider such as the provider 150, a media distributor such as the VOD provider operating the headend 120, or some combination of these entities. Moreover, although the virtual asset management functions, the content provision functions, and the cable headend processing functions are shown as being performed by different processors at different locations, these functions may be performed at the same location by the same or different processors.

As contemplated by the present invention, additional capabilities can be incorporated into the DVD player 20 to enable it perform metadata based functions. The needed metadata may be obtained via the Internet or the cable network from a metadata source 160, may be supplied as a pre-recorded part of a DVD or CD disk 10, may be created or edited on the PC 90, or may be obtained or exchanged with other users via the Internet as indicated at 300. To store and use metadata and executable programs using metadata, the DVD player 20 includes a limited internal memory (solid-state or otherwise) as indicated at 50, or may contain a hard drive for greater content storage, or may store information in any number of remote locations. In this case, content, metadata or programs may called upon and streamed from the remote location when required. This option reduces the need for local memory or storage within the DVD player 20 itself. The DVD player may be able to burn DVDs (or even CDs) locally, allowing the user to save content on a removable media in the library 10 for later viewing or viewing elsewhere.

As indicated at 70, the DVD player may be connected to the Internet, a local PC, a remote file server, or to any other non-local digital content repository. The DVD player may stream or download content from a PC, via the Internet, or via some other means of connectivity. The DVD player may stream or upload content via the interface 70 to a remote location for remote playback or remote storage.

As described in the above-noted U.S. Patent Application Publication Nos. 2002/0120925 and 2003/0093790, metadata may be shared by different users. As contemplated by the present invention, the DVD player 20 preferably includes means which allow users to mark their favorite scenes. A common pastime among some movie buffs is to play a part of a movie simply to watch one or two scenes. Metadata may be recorded to mark these scenes, allowing them to be played again whenever the bookmarked DVD volume is placed in the transport 40. In this general implementation, some local metadata about the DVD may need to be stored on the user's computer. Basically, the system needs to recognize the DVD and keep a list of user-created bookmarks for application to the content. The stored metadata created can be viewer-specific, allowing each viewer to identify his or her own selected favorite passages on any DVD. For example, using the “community markup” mechanisms described in Publication Nos. 2002/0120925 and 2003/0093790, users may create previews, playlists, or content annotations that may be shared with and used by other users. For example, using the remote control with the DVD player 20, the user may “bookmark” passages in DVD disk content, marking favorite segments to create metadata that can be automatically uploaded to a centralized server. Any viewer who is later watching the same DVD can then access other users' favorite segments (for example, Jim's best battle scenes, or Dan's favorite car crashes, etc.).

To increase the enjoyment of DVD disk content, special playlists recorded as metadata may be downloaded playlists which identify edited/abridged versions of a DVD, only the best parts, and other types of playlists. The user can skip around through a playlist, employing or disregarding the playlist filter instantly and at will. All content can always be available, but the playlists can allow instant adjustments to the content. An illustrative mechanism employing a playlist to identify and control the navigable content of referenced media is described in the above-noted U.S. Pat. No. 6,199,076 issued on Mar. 6, 2001 to James D. Logan et al. entitled “Audio Program Player including a Dynamic Program Selection Controller.” Examples of playlists that might be applied to advantage in connection with the following illustrative types of media content:

A. Sports—best hits, best plays, follow a particular player. The methods described in U.S. patent application Ser. No. 10/767,930 filed on Jan. 29, 2004, now published as Publication No. 2005/0005308, the disclosure of which is incorporated herein by reference, may be employed to control the DVD player playback to enhance the enjoyment of recorded sports programming.

B. Movies—best scenes, Best crashes, etc.

C. Fitness—Highlights of each exercise without details. Fitness is a particularly good example of possible special markups. A fitness DVD may have 50 exercises on it and provide the user with 20 unique workout sessions that mix and match the various exercises embedded. Each of the exercises might be in multiple playlists, while some might only be found in one playlist. Alternately, users could construct personal playlists from the entire content set available in their library 10. In keeping with the previous example, a user could generate their own exercise plan from a superset of exercises available on a DVD.

These playlists may or may not be available as a part of a subscription service. The user interfaces for easy navigation described in the above may be used to provide DVD player navigation functions which supplement other DVD menu structures. This interface preferably provides a multi-tiered or single-tiered menu on the side of the TV screen 101, details about content on the bottom, and the rest of the screen filled with video. The displayed metadata may overlay on the video. As with the VOD version described in the earlier applications, the bottom window could potentially be used for advertising related content or products. The essence of this interface is the juxtaposition of an index to the content with the video itself, and the ability to navigate through the video while the video plays.

New playlists may be created via the DVD remote control and saved locally on the player, or playlists could be created or downloaded on PC 90 and then uploaded via any means of connectivity to the DVD player 20.

A content server 150 or a metadata server 180 may make “previews” including, say, 200 short scenes, and users could obtain these previews on a physical disk, or download them via the Internet, and then create playlists and make storylines out of the scenes. The playlist metadata could be uploaded to a server and downloaded by other owners of a compatible, metadata enabled DVD player.

The DVD player may be used to enable general connectivity for interactive DVD extras. Extra “connected” content related to a DVD could be made available; for example, a Patriots 2003 Season Highlights CD might automatically provide the user with a downloaded schedule for the 2004 games, if they are available. This ancillary content could be identified on the purchased CD by a URL recorded on the DVD disk or in metadata provided by the metadata supplier 180, enabling an Internet connection to be established to access dynamically changing current metadata about the DVD media content. The URL may specify an Internet resource 310 which provides content related to the media content on a DVD. Such new or ancillary content could be not only be added to, but also interspersed within the content originating from the DVD. The additional content can be streamed directly into the DVD player via the cable network or Internet interface, or downloaded onto the PC 90 and uploaded to the DVD player 20. The content may be stored on internal DVD memory or the new content could be burned directly to a recordable or re-recordable DVD which may also hold the content described by the metadata. To facilitate digital rights management, the DVD player may be programmed to require that a particular DVD be mounted on the transport 40 before related content from another source can be reproduced. This allows a rather robust DRM scheme to prevent non-owners of a DVD from accessing additional copyrighted content with owner permission.

The DVD player may also provide a content related connection to allow remote product purchasing from movie/DVD product placement through an interface to a Internet resource 310 such as an Internet sales server, or to a telephone dialup ordering service. For example, the system could use some screen space to indicate where the Dr. Pepper that the actor is drinking in a viewed movie can be purchased. The required product placement metadata information may be carried by the DVD itself or may be downloaded to the DVD player 20 as discussed above.

Embedded Movie user ratings. When a DVD volume is mounted, or when a preview or listing of available content is displayed, additional data concerning the content may be downloaded. For example, users can rate a movie they just watched, submit their rating to a central server, and the resulting rating data may be made available to other users who are attempting to select content for viewing. The rating mechanism could be seamless to the user, similar to the multiple thumbs up/thumbs down function used in TiVo PVRs to rate broadcast programming, or programs may be rated in other ways, such a more traditional 0-5 rating.

The hard drive 60 in the DVD player may be used to provide a vault for storing selected content from a DVD. An entire segment to be saved to the vault, either manually selecting the start/stop or automatically selecting the start/stop based on metadata about the current segment. The hard drive may employ encryption or similar DRM protections for the copied segment. Alternately, the content creator may allow or disallow specific segments to be saved; for example, preview content on a DVD may be made freely sharable because it promotes the purchase of the previewed content.

The DVD player 20 may be adapted to “hot-swap” content using the player's interface via the Internet. In a system combined with a hard drive, the system can save a “preview” for all owned content in the library 10 into the system. The user can later watch previews and decide what movie to watch. Previews can be created from metadata about the movie that can determine what content to copy from the movie to be part of the preview. Alternately, preview can be downloaded from a video server to the connected DVD player upon DVD insert. An extension of the preview capability would allow downloading of new previews related to the current DVD. For example, if a user is watching “Terminator 2”, the preview for “Terminator 3” may be downloaded automatically when it becomes available. An external server could match DVDs to possibly interesting movie previews and the system could push the previews to the DVD player.

Using the techniques described in the above-noted copending U.S. patent application Ser. No. 09/782,546 filed on Feb. 13, 2001 (a division of application Ser. No. 08/724,813 now U.S. Pat. No. 6,199,076 issued on Mar. 6, 2001 to James D. Logan et al. and entitled “Audio Program Player including a Dynamic Program Selection Controller”), the content provider may organize program segments by subject matter and deliver programs, or metadata identifying programs, which are of interest to a particular subscriber in accordance with preferences associated with each subscriber. Program segments are associated with descriptive subject matter segments, and the subject matter segments may be used to generate cataloging presentations to enable the user to more easily identify and select desirable programming. The programming content may be identified in a playlist which the playback unit at the subscriber location employs automatically reproduce program segments identified in the playlist, and includes mechanisms for interactively navigating among the program segments using the playlists. A usage log compiled to record the subscriber's use of the provided program materials may be uploaded to the content provider from the subscriber location, thereby providing the host with data for billing, to adaptively modify the subscriber's preferences based on actual usage, and to send subscriber-generated comments and requests to the host for processing. The program segments sent to each subscriber may include advertising materials.

If a DVD is rented, not owned, and the user enjoys it, she may wish to buy the DVD later. In this spirit, the system could offer a means to make purchasing the DVD easy, either through connectivity in the DVD player or by creating a list of “liked content” on the DVD player that the user can refer to prior to a DVD purchase. One possible implementation could allow the entire purchase to occur on the DVD player via menus, charging a previously setup account. Prices offered could be dynamic based on any number of possible promotions, which may even correlate to the DVD rental company. Yet another implementation could allow a dynamic, menu driven purchase of the rented DVD to be copied to a DVD player with a built-in hard drive. The user's account could be automatically charged and the content could be transferred to the local hard drive for later viewer. This service provides a faster and, possibly, less expensive means of purchasing a content license.

The system could offer ads from sponsors that relate to the type of content on the DVD. For example, if the user is watching a Pilates DVD describing a fitness regimen, metadata may be used to makes it easy to purchase a “Pilates Ball” which the view may use for excercise. The system could also offer a list of DVDs that are similar to the content being watched. For example, if the user is watching a Yoga DVD, a Pilates DVD may be on the list. The suggested DVDs could be based on any number of functions, including, but not limited to, DVD description, DVD “store” categorization, collaborative filtering, sponsor-based suggestions, etc.

Conclusion

It is to be understood that the methods and apparatus which have been described above are merely illustrative applications of the principles of the invention. Numerous modifications may be made by those skilled in the art without departing from the true spirit and scope of the invention.

What is claimed is:

1. A method for distributing and managing virtual copies of the content of physical disk media assets comprising, in combination, the steps of:
maintaining a virtual asset database which identifies the media assets to which purchasers may be given access pursuant to purchase contracts,
distributing metadata to prospective purchasers containing a catalog of said media assets which are available for purchase from one or more content providers,
establishing said purchase contracts between content providers and purchasers, establishing and maintaining customer records reflecting, for each given one of said purchasers, the identification of each media asset purchased by said given one of said purchasers, the terms upon which each of said purchased asset may be used by said given one of said purchasers, and history of the actual use of that asset by said given purchaser; and
delivering said media asset as data to said purchasers via a communications link in response to requests received from said purchasers, and
performing accounting functions relating to the purchase and delivery of said media assets to said purchasers.
